(19) United States
(12) Patent Application Publication
(10) Pub. No.: US 2026/0150851 A1
(43) Pub. Date: Jun. 4, 2026

(54) PANCAKE MAKER EQUIPPED WITH DETACHABLE BAKING TRAYS

(71) Applicant: Apecoo LLC, San Jose, CA (US)

(72) Inventors: Tingbin TANG, San Jose, CA (US); Jianming CHEN, San Jose, CA (US); Peng XIAO, San Jose, CA (US)

(73) Assignee: Apecoo LLC, San Jose, CA (US)

(21) Appl. No.: 19/458,602

(22) Filed: Jan. 23, 2026

(51) Int. Cl. A21B 5/03

(52) U.S. Cl. CPC A21B 5/03

(57) ABSTRACT

A pancake maker equipped with detachable baking trays comprises: a main body, which comprises at least two body housings capable of opening or closing relative to each other; wherein each of the body housings is provided with a baking tray, a locking assembly and a first elastic assembly are arranged between each baking tray and its corresponding body housing; when the locking assembly is switched to the locked state, it locks the corresponding baking tray on the body housing; when the locking assembly is switched to the unlocked state, it releases locking between the corresponding baking tray and the body housing, and the baking tray moves along the direction of detaching from the corresponding body housing under the reset action of the first elastic assembly. When disassembling the baking tray, the baking tray pops out automatically under the reset action of the first elastic assembly, facilitating user operation.

### BACKGROUND

### 1. Technical Field

The present invention belongs to the field of cooking appliances, and specifically relates to a pancake maker equipped with a detachable baking tray.

### 2. Background Information

Presently, pancake maker as a popular household cooking appliance, it heats and shapes batter into foods such as waffles and hash browns through its upper and lower heating baking trays with specific cavities (e.g., traditional squares, circles, heart shapes, etc.). The basic structure of a pancake maker usually comprises two hinged body housings, each body housing provided with a baking tray. For existing pancake makers on the market, the baking tray and the body housing are mostly integrally formed or fixedly connected. In the prior art, the baking trays of some pancake makers are designed to be detachable from the body for easy cleaning or replacement. However, when disassembling such detachable baking trays, users usually need to apply a relatively large force directly with their hands or tools for prying or pulling the baking tray out of the body. This disassembly operation is inconvenient and labor-intensive, and there is a risk of scratching the user or damaging the baking tray, resulting in poor user experience.

### BRIEF SUMMARY

The present invention provides a pancake maker equipped with detachable baking trays, aiming at solving the problem of poor user experience caused by inconvenient operation when disassembling and assembling the baking tray of pancake makers in the prior art.

In order to solve the above technical problem, the present invention adopts the following technical solution.

A pancake maker equipped with detachable baking trays, comprising:
a main body, which comprises at least two body housings capable of opening or closing relative to each other; wherein each of the body housings is provided with a baking tray, a locking assembly and a first elastic assembly are arranged between each of the baking trays and its corresponding body housing;
the locking assembly comprises a locked state and an unlocked state; when the locking assembly is switched from the unlocked state to the locked state, the locking assembly locks the corresponding baking tray onto the body housing and the first elastic assembly is compressed; when the locking assembly is switched from the locked state to the unlocked state, the locking assembly releases locking between the corresponding baking tray and the body housing, and the baking tray moves along a direction of detaching from the corresponding body housing under the reset action of the first elastic assembly.

As a further solution, at least a receiving portion is disposed on the body housing, and an insertion portion is disposed on the baking tray, when the baking tray is mounted on the corresponding body housing, the insertion portion is inserted into the receiving portion.

As a further solution, each of the body housings is provided with a connecting portion, and two of the connecting portions are pivotally connected.

At least a slot or insertion hole is disposed on a side of each body housing close to the connecting portion, and the first elastic assembly is arranged on the other side of each body housing away from the connecting portion between the body housing and the baking tray.

Based on the above technical solution: by arranging the slot or insertion hole on a side of the body housing close to the connecting portion, which is matched with the insertion portion on the baking tray, initial positioning is provided for mounting the baking tray. During installation, first align the side of the baking tray provided with the insertion portion with the slot on the body housing, and then press the other side of the baking tray downward to switch the locking assembly to the locked state. This ensures that the baking tray is accurately positioned before being locked, facilitating the smooth switching of the locking assembly to the locked state. Meanwhile, this insertion structure also shares part of the load of the baking tray, enhancing the overall stability. During disassembly, the side of the baking tray away from the connecting portion is first lifted up by the first elastic assembly, thereby facilitating the user to pull the baking tray upward and outward.

As a further solution, an abutting portion is slidably disposed on the body housing; the first elastic assembly is arranged between the abutting portion and the body housing, and the first elastic assembly drives the corresponding baking tray to move along the direction of detaching from the body housing via the abutting portion.

Based on the above technical solution: the slidable abutting portion is provided as a force transmission medium between the first elastic assembly and the baking tray, so that the acting force of a spring is uniformly transmitted to the back of the baking tray through a flat interface. This avoids point contact, and enables the baking tray to bear force more uniformly; thus, the ejection movement is more stable.

As a further solution, at least two guide posts are arranged side by side on the body housing, and the abutting portion is slidably disposed on two of the guide posts.

Based on the above technical solution: at least two parallel guide posts are adopted to guide the sliding of the abutting portion, ensuring that the abutting portion only slide along a preset linear trajectory, thus ensuring the smoothness and reliability of the ejection movement and preventing misalignment or jamming.

As a further solution, the first elastic assembly comprises at least one first spring; the abutting portion is provided with at least one third mounting seat, and the body housing is provided with at least one fourth mounting seat; each of the first springs is disposed between the corresponding third mounting seat and fourth mounting seat.

As a further solution, the locking assembly comprises:
a first locking portion disposed on the baking tray;
a second locking portion disposed on the body housing;
a second elastic reset assembly configured for driving the second locking portion to move toward the first locking portion and to lock with the first locking portion; and
an unlocking portion disposed on the body housing for driving the second locking portion to move away from the first locking portion and to release locking with the first locking portion.

Based on the above technical solution: a continuous locking force is provided by the second elastic reset assembly to keep the first locking portion and the second locking portion in the locked state; meanwhile, manual unlocking is achieved via an independent unlocking portion. This design enables convenient and controllable unlocking on the premise of ensuring firm and reliable locking.

As a further solution, the second locking portion is integrally formed or fixedly connected with the unlocking portion, and a pressing portion is disposed on the unlocking portion.

Based on the above technical solution: integrating the second locking portion and the unlocking portion as a whole or connecting them fixedly simplifies the quantity and structure of movable components, ensures a direct linkage between the unlocking action and the displacement of the locking portion, and makes the control feedback more accurate and timely; the provision of the pressing portion facilitates user operation.

As a further solution, both the second locking portion and the unlocking portion are slidably disposed on the body housing, and at least one guiding device is arranged between the unlocking portion and the body housing.

As a further solution, each of the guiding devices comprises a guiding hole and a sliding portion slidably disposed in the guiding hole;
the guiding hole is disposed on the unlocking portion, and the sliding portion is disposed on the body housing; or the guiding hole is disposed on the body housing, and the sliding portion is disposed on the unlocking portion.

Based on the above technical solution: the structure of the above guiding device is configured for restricting the sliding stroke of the unlocking portion relative to the body housing, avoiding excessive pressing during unlocking; meanwhile, the cooperation between the sliding portion and the guiding hole enables the second locking portion and the unlocking portion to slide along a predetermined path during unlocking or locking, thus avoiding deviation.

As a further solution, two of the guiding devices are arranged side by side between the unlocking portion and the body housing.

As a further solution, the first locking portion is a clamping groove, and the second locking portion is a clamping hook;
or the first locking portion is a clamping hook, and the second locking portion is a clamping groove;

As a further solution, a guiding slope is provided on an upper side of the second locking portion, when the baking tray is mounted on the body housing, the first locking portion slides obliquely along the guiding slope, and drives the second locking portion to move away from the first locking portion and to compress the second elastic reset assembly;
when the first locking portion slides to a position where it is locked with the second locking portion, the second locking portion moves toward the first locking portion under the action of the second elastic reset assembly and is locked with the first locking portion.

Based on the above technical solution: the provision of the guiding slope on the second locking portion enables self-locking of the baking tray by pressing during installation. When mounting the baking tray, it is only necessary to press the baking tray downward so that the first locking portion on the baking tray slide along the slope and automatically push the second locking portion away until the first locking portion and the second locking portion are engaged and locked. This simplifies the installation operation and enables convenient installation of the baking tray.

As a further solution, a first mounting seat is provided on the body housing, a second mounting seat is provided on the second locking portion, and the second elastic reset assembly comprises a second spring, which is arranged between the first mounting seat and the second mounting seat.

Beneficial effects of the present invention:

The present invention, through an integrated synergistic action of a “locking assembly” and a “first elastic assembly” provided between each baking tray and the body housing, enables the locking assembly to lock the corresponding baking tray onto the body housing and causes the first elastic assembly to store elastic energy when the locking assembly switches to a locked state. When the locking assembly is switched to the unlocked state, the compressed first elastic assembly actively drive the baking tray to generate initial displacement without requiring additional force from the user, making the baking tray partially detach from the housing. This fundamentally changes traditional detachment mode that completely relies on external pulling force or prying, thereby realizing automation of the baking tray detach process, facilitating user operation, and providing users with a better experience. In addition, users can replace the baking tray to make waffles of different shapes, as well as hash browns, bread and other foods; alternatively, the baking tray can be detached for convenient cleaning.

When detaching the baking tray, the initial displacement of the baking tray automatically ejected under the reset action of the first elastic assembly provides an operating space for users to easily grasp the baking tray, thereby reducing the risk of hand contact with the baking tray with high temperature or sharp edges and lowering the operational risk.

### BRIEF DESCRIPTION OF THE DRAWINGS

In order to illustrate the technical solutions in the embodiments of the present invention more clearly, the accompany drawings required in the embodiments will be briefly introduced hereafter. It should be understood that the accompany drawings in the following merely illustrate some embodiments of the present invention and, therefore, should not be regarded as limiting the scope thereof. For those of ordinary skill in the art, other accompany drawings can be obtained based on these drawings without exerting creative efforts.

FIG. 1 is a structural schematic view of a pancake maker equipped with detachable baking trays.

FIG. 2 is a cross-sectional schematic view of the locking assembly.

FIG. 3 is a cross-sectional schematic view of the first elastic assembly.

FIG. 4 is a cross-sectional schematic view of the first elastic assembly and the guiding device.

FIG. 5 is an exploded schematic view of the baking tray and the body housing from a first perspective.

FIG. 6 is an exploded schematic view of the baking tray and the body housing from a second perspective.

FIG. 7 is an enlarged schematic view of the structure at position A in FIG. 6.

FIG. 8 is a schematic view of the rear side structure of the main body.

FIG. 9 is an enlarged schematic view of the structure at position B in FIG. 8.

FIG. 10 is an exploded schematic view of the first locking portion and the second locking portion.

### DESCRIPTION OF REFERENCE NUMERALS IN THE FIGURES

1—main body; 11—body housing; 11a—first body housing; 11b—second body housing; 111—slot; 112—insertion hole; 113—guide post; 114—abutting portion; 114a—third mounting seat; 114b—vertical plate; 114c—base plate; 116—fourth mounting seat; 117—first mounting seat; 118—connecting portion; 119—receiving portion; 12—motor; 2—baking tray; 2a—first baking tray; 2b—second baking tray; 21—insertion portion; 211—insertion block; 3—first elastic assembly; 31—first spring; 4—cooking cavity inlet; 5—locking assembly; 51—first locking portion; 511—clamping groove; 52—second locking portion; 521—clamping hook; 522—guiding slope; 523—second mounting seat; 53—second elastic reset assembly; 531—second spring; 54—unlocking portion; 541—pressing portion; 6—guiding device; 61—sliding portion; 62—guiding hole.

### DETAILED DESCRIPTION OF THE DRAWINGS AND THE PRESENTLY PREFERRED EMBODIMENTS

The technical solutions in the embodiments of the present invention will be described clearly and completely below with reference to the accompanying drawings in the embodiments of the present invention. It should be understood that the embodiments described here are only used for explaining the present invention but not to limit the present invention. All other embodiments obtained by those skilled in the art without creative efforts based on the embodiments of the present invention shall fall within the scope of protection of the present invention.

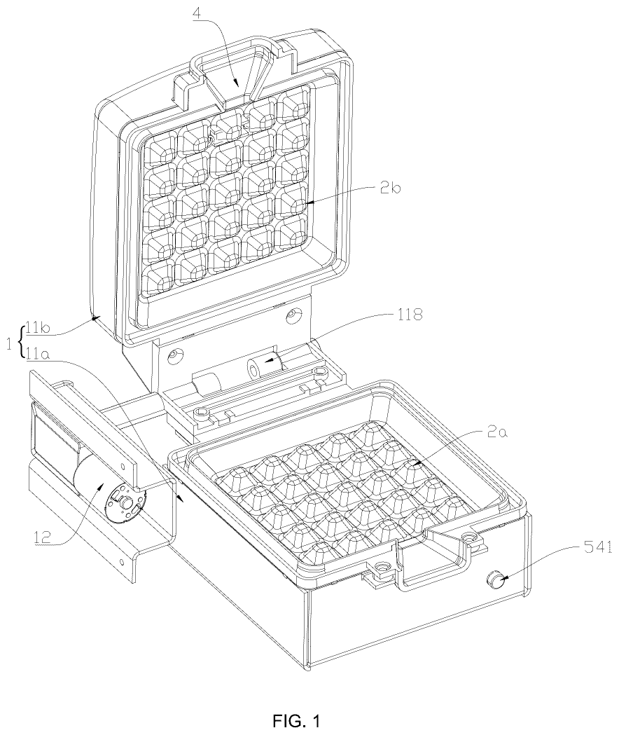

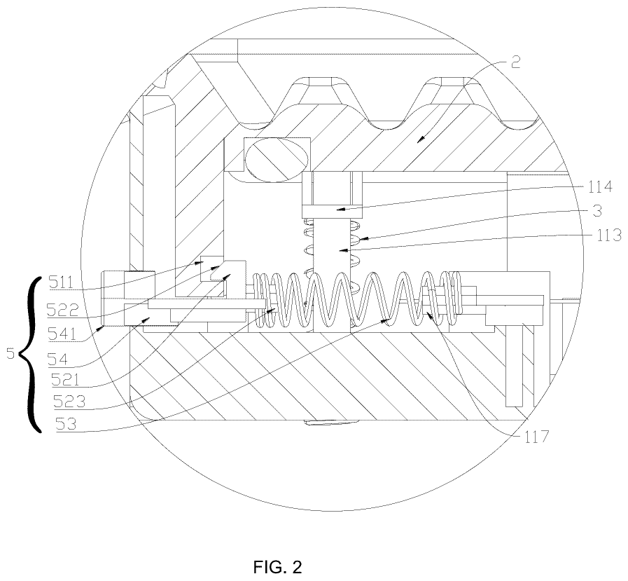

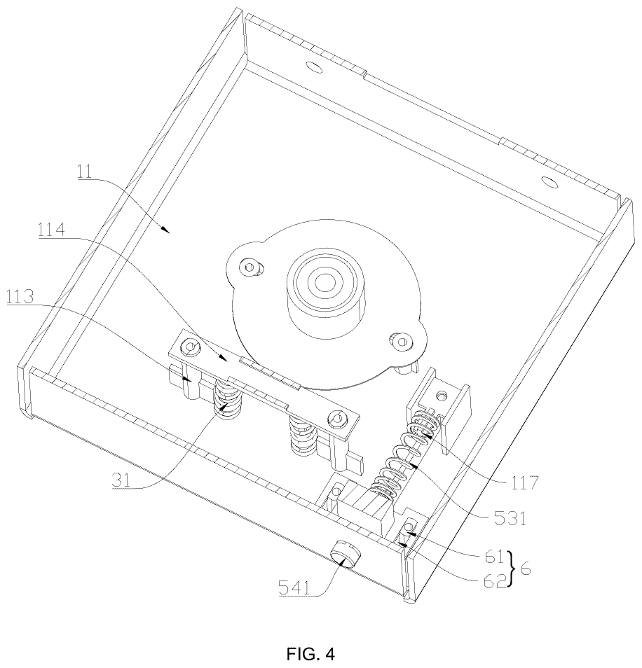

As shown in FIG. 1, FIG. 2 and FIG. 4, the present embodiment provides a pancake maker equipped with detachable baking trays, comprising:
a main body 1, which comprises at least two body housings 11 capable of opening or closing relative to each other, namely a first body housing 11a and a second body housing 11b; wherein each of the body housings 11 is provided with a baking tray 2, specifically, a first baking tray 2a is disposed on the first body housing 11a, and a second baking tray 2b is disposed on the second body housing 11b; a locking assembly 5 and a first elastic assembly 3 are arranged between each of the baking trays 2 and its corresponding body housing 11.

The locking assembly 5 comprises a locked state 6 and an unlocked state 7; when the locking assembly 5 is switched from the unlocked state 7 to the locked state 6, the locking assembly 5 locks the corresponding baking tray 2 onto the body housing 11 and the first elastic assembly 3 is compressed; when the locking assembly 5 is switched from the locked state 6 to the unlocked state 7, the locking assembly 5 releases locking between the corresponding baking tray 2 and the body housing 11, and the baking tray 2 moves along a direction of detaching from the corresponding body housing 11 under the reset action of the first elastic assembly 3, thereby popping the baking tray 2 out by a certain distance for facilitating user to take off the baking tray 2.

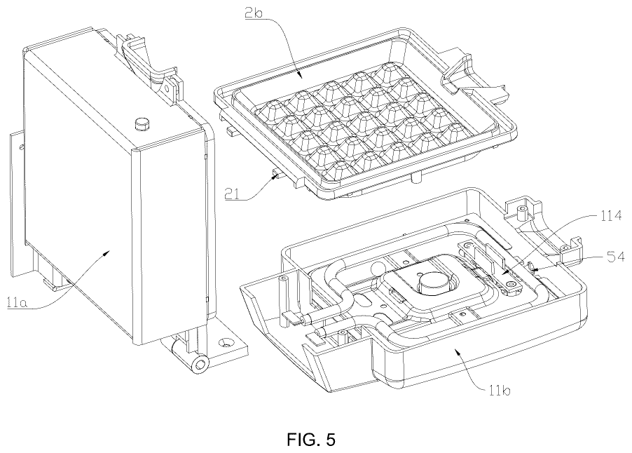

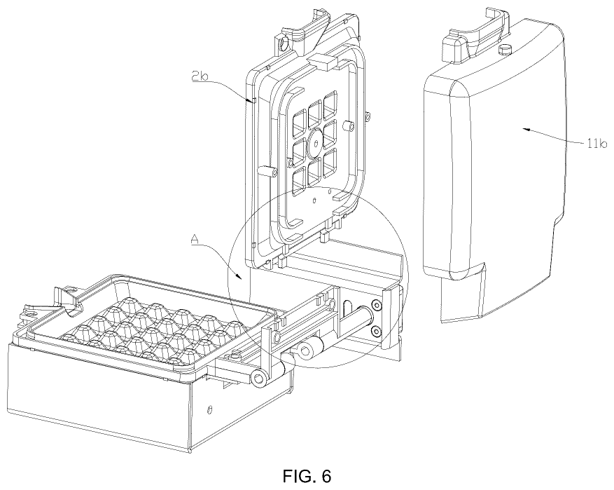

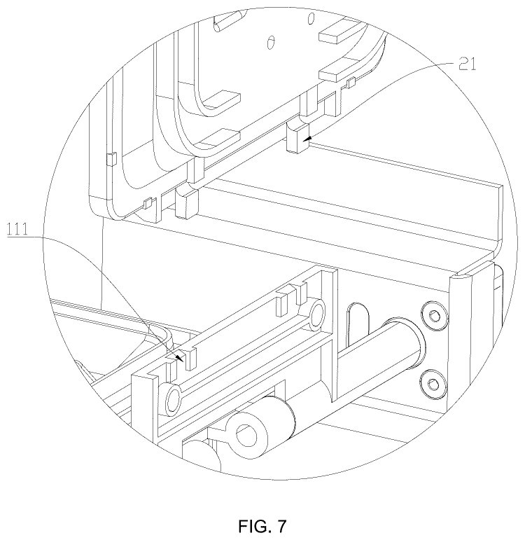

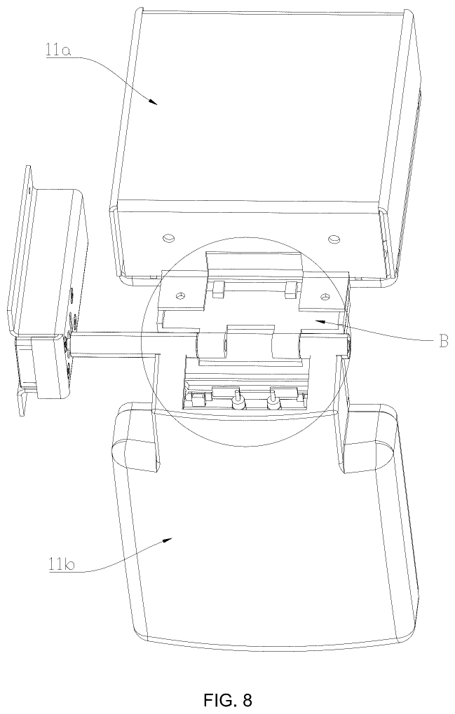

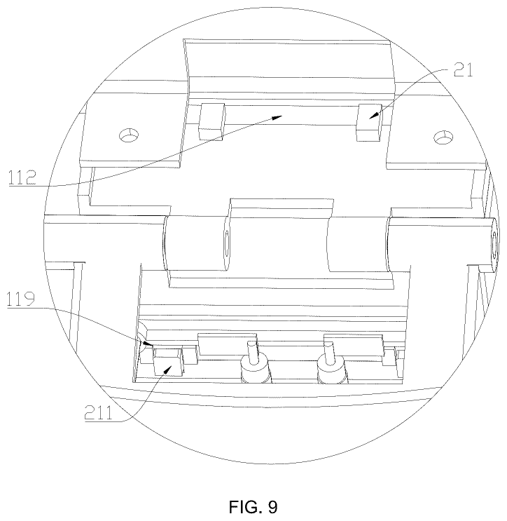

In some specific embodiments, as shown in FIG. 5 to FIG. 9, the body housing 11 is provided with at least a receiving portion 119, specifically a slot 111 or insertion hole 112; and the baking tray 2 is provided with an insertion portion 21. When the baking tray 2 is mounted on the corresponding body housing 11, the insertion portion 21 is inserted into the corresponding slot 111 or insertion hole 112.

Specifically, each of the body housing 11 is provided with a connecting portion 118, and two of the connecting portions 118 are pivotally connected.

The slot 111 or insertion hole 112 is disposed on a side of each body housing 11 close to the connecting portion 118, and the first elastic assembly 3 is arranged on the other side of each body housing 11 away from the connecting portion 118 between the body housing 11 and the baking tray 2. Each baking tray 2 is provided with a cooking cavity inlet 4, and the cooking cavity inlet 4 and the insertion portion 21 are located on opposite sides of the baking tray 2 respectively. During installation, first align the insertion portion 21 on the baking tray 2 with the slot 111 or insertion hole 112 on the body housing 11, then press the baking tray 2 downward to switch the locking assembly 5 to the locked state 6, thereby locking the baking tray 2 onto the corresponding body housing 11.

Optionally, the insertion portion 21 comprises two insertion blocks 211. When mounting the baking tray 2, two of the insertion blocks 211 are inserted into two of the slots 111 or insertion holes 112 on the body housing 11 respectively.

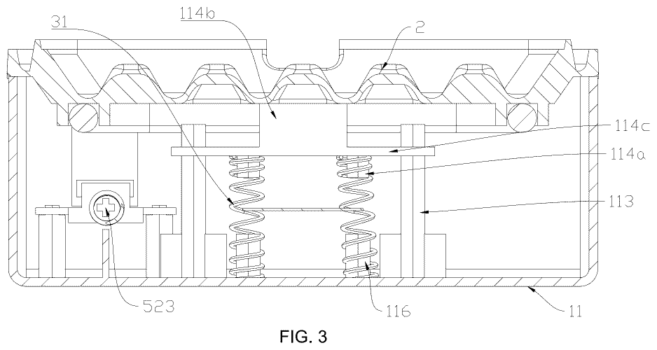

In some specific embodiments, as shown in FIG. 3 and FIG. 4, for facilitating the installation of the first elastic assembly, an abutting portion 114 is slidably disposed on the body housing 11. The first elastic assembly 3 is arranged between the abutting portion 114 and the body housing 11, and the first elastic assembly 3 drives the corresponding baking tray 2 to move along the direction of detaching from the body housing 11 via the abutting portion 114.

A specific solution is as follows: at least two guide posts 113 are arranged side by side on the body housing 11, and the abutting portion 114 is slidably disposed on two of the guide posts 113. The abutting portion 114 specifically comprises a base plate 114c for abutting against the first elastic assembly 3, and two vertical plates 114b arranged side by side on the base plate 114c and for abutting against the baking tray 2. The base plate 114c is slidably connected with two of the guide posts 113, thereby preventing misalignment or jamming.

Herein, the first elastic assembly 3 comprises at least one first spring 31; the abutting portion 114 is provided with at least one third mounting seat 114a, and the body housing 11 is provided with at least one fourth mounting seat 116; each of the first spring 31 is disposed between the corresponding third mounting seat 114a and fourth mounting seat 116. In a preferred embodiment, there are two first springs 31 arranged side by side, and the number of the third mounting seats 114a and the fourth mounting seats 116 is two each, so that the abutting portion 114 is subjected to a balanced force thereby sliding smoothly.

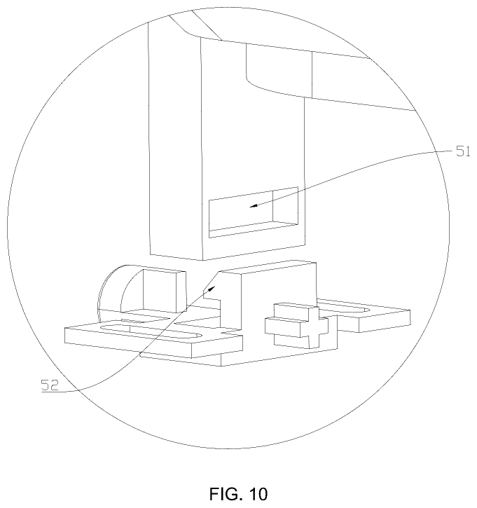

In some specific embodiments, as shown in FIG. 2 to FIG. 4 and FIG. 10, the locking assembly 5 comprises:
a first locking portion 51 disposed on the baking tray 2;
a second locking portion 52 disposed on the body housing 11;
a second elastic reset assembly 53 configured for driving the second locking portion 52 to move toward the first locking portion 51 and to lock with the first locking portion; and
an unlocking portion 54 disposed on the body housing 11 for driving the second locking portion 52 to move away from the first locking portion 51 and to release lock with the first locking portion, thereby facilitating user operation during unlocking.

Herein, the second locking portion 52 and the unlocking portion 54 are preferably integrally formed or fixedly connected; in addition, a pressing portion 541 is provided on the unlocking portion 54, and the pressing portion 541 is disposed to be exposed out of the body housing 11, thereby facilitating the user pressing operation.

Herein, both the second locking portion 52 and the unlocking portion 54 are slidably disposed on the body housing 11, and at least one guiding device 6 is arranged between the unlocking portion 54 and the body housing 11.

Specifically, each of the guiding devices 6 comprises a guiding hole 62 and a sliding portion 61 slidably disposed in the guiding hole 62;
the guiding hole 62 is disposed on the unlocking portion 54, and the sliding portion 61 is disposed on the body housing 11;
alternatively, the guiding hole 62 is disposed on the body housing 11, and the sliding portion 61 is disposed on the unlocking portion 54; The sliding portion 61 and the guiding hole 62 cooperate with each other, preventing the unlocking portion 54 from being excessively pressed during unlocking; meanwhile, the cooperation between the sliding portion 61 and the guiding hole 62 enables the second locking portion 52 and the unlocking portion 54 to slide along a predetermined path during unlocking or locking, thereby avoiding deviation.

In a preferred embodiment, two of the guiding devices 6 are arranged side by side between the unlocking portion 54 and the body housing 11. Moreover, two of the guiding devices 6 are located on opposite sides of the unlocking portion 54 respectively, thereby avoiding deviation during the pressing of the unlocking portion 54 due to the action of the left and right of the guiding device 6.

In some specific embodiments, as shown in FIG. 2, the first locking portion 51 is a clamping groove 511, and the second locking portion 52 is a clamping hook 521;
alternatively, the first locking portion 51 is a clamping hook 521, and the second locking portion 52 is a clamping groove 511;

Herein, in order to enable the second locking portion 52 to be smoothly locked with the first locking portion 51 when mounting the baking tray 2, a guiding slope 522 is provided on an upper side of the second locking portion 52. When mounting the baking tray 2 on the body housing 11, the first locking portion 51 slides obliquely along the guiding slope 522, and drives the second locking portion 52 to move away from the first locking portion 51 and to compress the second elastic reset assembly 53;
when the first locking portion 51 slides to a position where it is locked with the second locking portion 52, the second locking portion 52 moves toward the first locking portion 51 under the action of the second elastic reset assembly 53 and is locked with the first locking portion 51. Thereby achieving self-locking of the baking tray 2 by pressing during installation, which simplifies the installation operation and realizes convenient installation of the baking tray 2. When detaching the baking tray 2, the user presses the pressing portion 541 so that the unlocking portion 54 drive the second locking portion 52 to move away from the first locking portion 51, thereby releasing the lock. Thereafter, under the reset action of the first elastic reset assembly, the baking tray 2 moves away from the body housing 11 and is ejected.

In some specific embodiments, as shown in FIG. 2 and FIG. 4, a first mounting seat 117 is provided on the body housing 11, and a second mounting seat 523 is provided on the second locking portion 52. The second elastic reset assembly 53 comprises a second spring 531, which is arranged between the first mounting seat 117 and the second mounting seat 523.

In some specific embodiments, opening or closing of two of the body housings 11 is driven by a motor 12, thereby facilitating user operation.

The description of working principle:

During installation, first align the insertion portion 21 on the baking tray 2 with the slot 111 or insertion hole 112 on the body housing 11; then press the baking tray 2 downward, causing the first locking portion 51 to slide obliquely along the guiding slope 522, and driving the second locking portion 52 to move relative to the body housing 11 in a direction away from the first locking portion 51 and to compress the second elastic reset assembly 53. When the first locking portion 51 slides to the position where it locks with the second locking portion 52, the second locking portion 52 moves toward the first locking portion 51 under the action of the second elastic reset assembly 53 and locks with the first locking portion 51. Thereby achieving self-locking of the baking tray 2 by pressing during installation. When detaching the baking tray 2, the user presses the pressing portion 541 so that the unlocking portion 54 drive the second locking portion 52 to move away from the first locking portion 51, thereby releasing the lock with the first locking portion 51. Thereafter, under the reset action of the first elastic reset assembly, the baking tray 2 moves away from the body housing 11 and is ejected, thereby enabling user to detach the baking tray 2 from the body housing 11.

The present invention is not limited to the above optional embodiments; on the premise that the various solutions are not mutually exclusive, any combination can be made between them. Any person may derive various other forms of products under the inspiration of the present invention. However, regardless of any changes in shape or structure thereof, all technical solutions falling within the scope defined by the claims of the present invention shall fall within the scope of protection of the present invention.

1. A pancake maker equipped with detachable baking trays, comprising:
a main body, which comprises at least two body housings capable of opening or closing relative to each other; wherein each of the body housings is provided with a baking tray, a locking assembly and a first elastic assembly are arranged between each of the baking trays and its corresponding body housing;
wherein the locking assembly comprises a locked state and an unlocked state; when the locking assembly is switched from the unlocked state to the locked state, the locking assembly locks the corresponding baking tray onto the body housing and the first elastic assembly is compressed; when the locking assembly is switched from the locked state to the unlocked state, the locking assembly releases locking between the corresponding baking tray and the body housing, and the baking tray moves along a direction of detaching from the corresponding body housing under a reset action of the first elastic assembly.

2. The pancake maker of claim 1, wherein at least a receiving portion is disposed on the body housing, and an insertion portion is disposed on the baking tray, when the baking tray is mounted on the corresponding body housing, the insertion portion is inserted into the receiving portion.

3. The pancake maker of claim 2, wherein each of the body housings is provided with a connecting portion, and two of the connecting portions are pivotally connected;
at least a slot or insertion hole as the receiving portion is disposed on a side of each body housing close to the connecting portion, and the first elastic assembly is arranged on the other side of each body housing away from the connecting portion between the body housing and the baking tray.

4. The pancake maker of claim 1, wherein an abutting portion is slidably disposed on the body housing; the first elastic assembly is arranged between the abutting portion and the body housing, and the first elastic assembly drives the corresponding baking tray to move along the direction of detaching from the body housing via the abutting portion.

5. The pancake maker of claim 4, wherein at least two guide posts are arranged side by side on the body housing, and the abutting portion is slidably disposed on two of the guide posts.

6. The pancake maker of claim 4, wherein the first elastic assembly comprises at least one first spring; the abutting portion is provided with at least one third mounting seat, and the body housing is provided with at least one fourth mounting seat; each of the first springs is disposed between the corresponding third mounting seat and the fourth mounting seat.

7. The pancake maker of claim 1, wherein the locking assembly comprises:
a first locking portion disposed on the baking tray;
a second locking portion disposed on the body housing;
a second elastic reset assembly configured for driving the second locking portion to move toward the first locking portion and to lock with the first locking portion; and
an unlocking portion disposed on the body housing for driving the second locking portion to move away from the first locking portion and to release locking with the first locking portion.

8. The pancake maker of claim 7, wherein the second locking portion is integrally formed or fixedly connected with the unlocking portion, and a pressing portion is disposed on the unlocking portion.

9. The pancake maker of claim 7, wherein both the second locking portion and the unlocking portion are slidably disposed on the body housing, and at least one guiding device is arranged between the unlocking portion and the body housing.

10. The pancake maker of claim 9, wherein each of the guiding devices comprises a guiding hole and a sliding portion slidably disposed in the guiding hole;
the guiding hole is disposed on the unlocking portion, and the sliding portion is disposed on the body housing; or the guiding hole is disposed on the body housing, and the sliding portion is disposed on the unlocking portion.

11. The pancake maker of claim 9, wherein two of the guiding devices are arranged side by side between the unlocking portion and the body housing.

12. The pancake maker of claim 7, wherein the first locking portion is a clamping groove, and the second locking portion is a clamping hook;
or the first locking portion is a clamping hook, and the second locking portion is a clamping groove.

13. The pancake maker of claim 7, wherein a guiding slope is provided on an upper side of the second locking portion, when the baking tray is mounted on the body housing, the first locking portion slides obliquely along the guiding slope, and drives the second locking portion to move away from the first locking portion and to compress the second elastic reset assembly;
when the first locking portion slides to a position where it is locked with the second locking portion, the second locking portion moves toward the first locking portion under an action of the second elastic reset assembly and is locked with the first locking portion.

14. The pancake maker of claim 7, wherein a first mounting seat is provided on the body housing, a second mounting seat is provided on the second locking portion, and the second elastic reset assembly comprises a second spring, which is arranged between the first mounting seat and the second mounting seat.
